(19) United States
(12) Patent Application Publication
(10) Pub. No.: US 2017/0199612 A1
(43) Pub. Date: Jul. 13, 2017

(54) TOUCH TOGGLED UNIT CONVERSIONS

(71) Applicant: SugarCRM Inc., Cupertino, CA (US)

(72) Inventor: Vladyslav Kulchytskyy, Nashua, NH (US)

(21) Appl. No.: 14/993,404

(22) Filed: Jan. 12, 2016

(51) Int. Cl. G06F 3/041

(52) U.S. Cl. CPC G06F 3/0416; G06F 3/0414

(57) ABSTRACT

A method for touch toggled unit conversions in a mobile computing device includes receiving a selection event for numerical data in a user interface (UI) displayed on the device and determining in response to the selection event if a unit conversion is available for the data and, if so, displaying a visual indication in the UI. Thereafter, a touch event is detected in the UI in connection with the data and in response, a unit conversion of the data is computed from an initial unit of measurement to a different unit of measurement, the data in the different unit of measurement is displayed in lieu of the data in the initial unit of measurement, and the data in the different unit of measurement is replaced with the data in the initial unit of measurement after the touch event is determined to have ended.

### BACKGROUND OF THE INVENTION

Field of the Invention

The present invention relates to computer driven unit conversions and more particularly to unit conversions in a mobile computing device.

Description of the Related Art

Mobile computing has advanced the way in which individuals live and work, providing instant access to vast volumes of information at the touch of a button on the screen of a device small enough to fit in one's pocket. Access to data via a mobile computing device often parallels that of data access in a desktop computer, combining the functionality of a Web browser with Internet access to conduct data queries over the World Wide Web. Of course, mobile data access is not limited merely to the World Wide Web and other modes of data access exist for mobile computing devices including direct access to private, remote data stores through an application user interface rendered in the mobile computing device.

Given the globalization of mobile computing, it is no longer reasonable to presume that all data is localized for a particular geographic location. Indeed, a data query performed in a mobile computing device while in one location may result in a result list on one language relevant to the location, the same data query performed in a mobile computing device in a different location may result in a completely different result list in a completely different language relevant to the different location. Thus, content providers tend to tailor content with location awareness to ensure the relevancy of the content delivered.

Part of location based relevancy includes the presentation of numerical values in an appropriate unit of measurement for a determined location. For instance, different locations are associated with different currencies. As well, temperature and distance measurements vary from location to location, some locations utilizing the imperial measurement system while other locations utilizing the metric system. As well, different locations reside in different time zones. However, for many end users, it is preferred to view numerical data in accordance with a familiar unit of measurement which may differ from the selected unit of measurement for a particular location. To do so, though, requires a manual conversion by the end user of the presented numerical data.

### BRIEF SUMMARY OF THE INVENTION

Embodiments of the present invention address deficiencies of the art in respect to unit conversion in a mobile computing device and provide a novel and non-obvious method, system and computer program product for touch toggled unit conversions in a mobile computing device. In an embodiment of the invention, a method for touch toggled unit conversions in a mobile computing device is provided. The method includes receiving a selection event for numerical data in a user interface displayed on a mobile computing device. In response, it is determined whether or not a unit conversion is available for the numerical data and, if so, a visual indication is displayed in the user interface.

Thereafter, a touch event is detected in the user interface in connection with the numerical data. The touch event is either sustained or deep touch. A sustained touch is a touch that persists for a threshold period of time. A deep touch is a touch that is measured to have a threshold amount of force. In response to the sustained or deep touch event, a unit conversion of the numerical data is computed from an initial unit of measurement to a different unit of measurement, and the numerical data is displayed in the different unit of measurement in lieu of the numerical data in the initial unit of measurement. But, the numerical data in the different unit of measurement is replaced with the numerical data in the initial unit of measurement after the touch event is determined to have ended.

In another embodiment of the invention, a data processing system is configured for touch toggled unit conversions in a mobile computing device. The system includes a mobile computing device having memory, a display and at least one processor. The system also includes a user interface to an application executing in the memory of the mobile computing device, the application displaying in the user interface numerical data in an initial unit of measurement. Finally, the system includes a touch toggled unit conversion module coupled to the user interface.

The module includes program code enabled during execution by the processor of the device to receive a selection event for the numerical data, to determine in response to the selection event whether or not a unit conversion is available for the numerical data and, if so, to display a visual indication in the user interface, to detect a sustained or deep touch event in the user interface in connection with the numerical data, and to respond to the touch event by computing a unit conversion of the numerical data from the initial unit of measurement to a different unit of measurement, by displaying the numerical data in the different unit of measurement in lieu of the numerical data in the initial unit of measurement, and by replacing the numerical data in the different unit of measurement with the numerical data in the initial unit of measurement after the touch event is determined to have ended.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for touch toggled unit conversions in a mobile computing device;

FIG. 2 is a schematic illustration of a mobile computing data processing system configured for touch toggled unit conversions; and,

FIG. 3 is a flow chart illustrating a process for touch toggled unit conversions in a mobile computing device.

### DETAILED DESCRIPTION OF THE INVENTION

Embodiments of the invention provide for touch toggled unit conversions in a mobile computing device. In accordance with an embodiment of the invention, a data query is transmitted from a user interface of a mobile computing device to a remotely disposed content server which in response, provides numerical data for display in the user interface of the mobile computing device. A touch input is received in connection with the numerical data on the user interface in response to which it is determined if a unit conversion of the numerical data is available. If so, a visual indication is presented in the user interface and in response to detecting a sustained or forceful enough touching of the user interface, the numerical data is unit converted to a different unit of measurement and presented in the user interface in lieu of the initially displayed numerical data. A release of the touching results in a reversion of the display to the initially displayed numerical data.

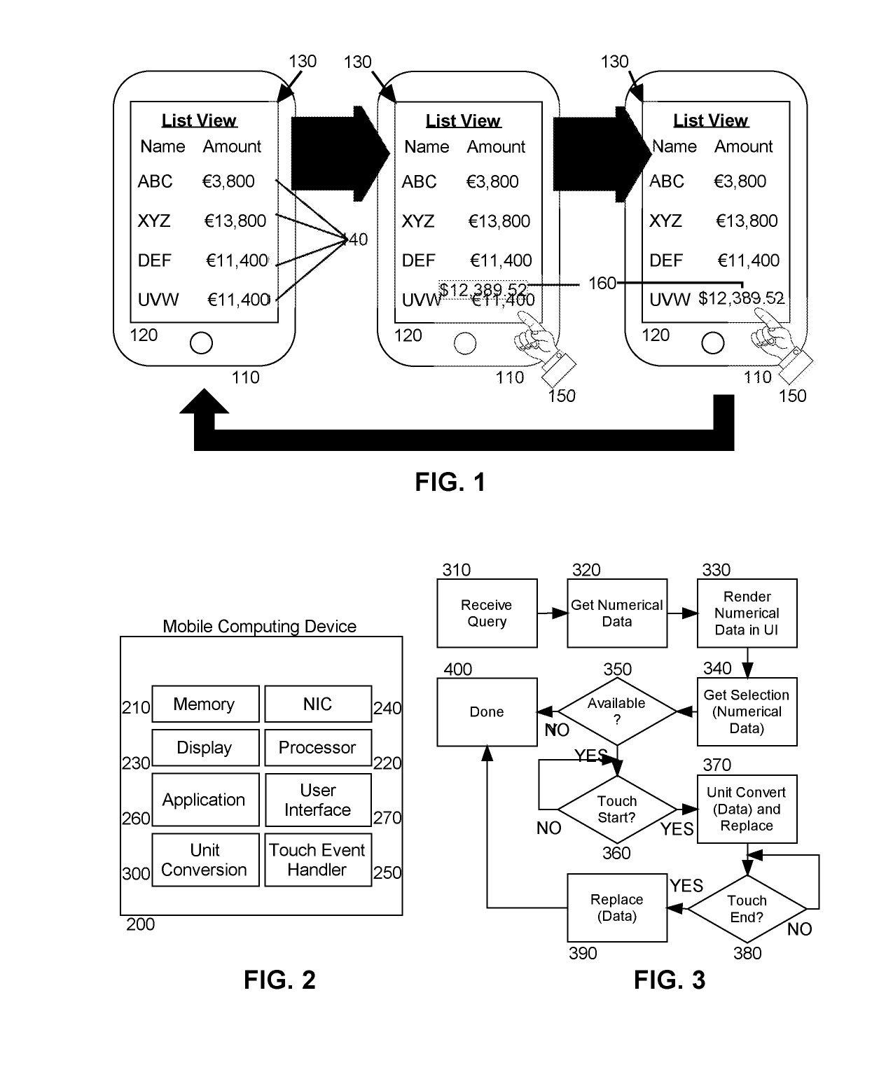

In further illustration, FIG. 1 pictorially shows a process for touch toggled unit conversions in a mobile computing device. As shown in FIG. 1, a list of numerical values 140 are presented in a list in a user interface 130 in a display 120 of a mobile computing device 110. In response to detecting a touching 150 of one of the numerical values 140, it is determined whether or not a unit of measurement conversion 160 is available for the selected one of the numerical values 140, for instance a currency conversion, a temperature conversion, a length or weight conversion or time zone conversion. If so, a visual indication is presented in the user interface 130. If the touching 150 then is sustained for a threshold period of time or is measured to be of a threshold force, a unit of measurement conversion is performed and the converted value 160 is presented in the user interface 130 in place of the selected one of the numerical values 140. Once the touching 150 ends, the selected one of the numerical values 140 replaces the converted value 160.

The process shown in connection with FIG. 1 is implemented in a mobile computing data processing system. In yet further illustration, FIG. 2 schematically shows a mobile computing data processing system configured for touch toggled unit conversions. The system includes a mobile computing device 200 having memory 210, one or processors 220, a display 230 and a network interface circuitry 240. An application 260 executes in the memory 210 of the mobile computing device 200 and provides a user interface 270 through which an end user retrieves data by way of the network interface circuitry 240 over a computer communications network, which data is displayed in the user interface 270.

Of note, a touch event handler 250 is coupled to the application 260 and traps touch events for supplemental processing. In this regard, the touch event handler 250 upon trapping a touch selection event in the user interface 270 for an underlying numerical value in the retrieved data, determines if a unit conversion is available for the underlying numerical value. If so, the touch event handler 250 invokes unit conversion module 300. The unit conversion module 300 includes program code enabled upon invocation to convert the underlying numerical value into a different unit of measurement and to return the converted value to the touch event handler 250. The touch event handler 250 then displays a visual indicator in the user interface 270 that unit conversion is available and in response to detecting a sustained or deep enough touching in the user interface 270 of the underlying numerical value, the underlying numerical value is replaced in the user interface 270 with the converted value. Once the touch is detected to have ended, the touch event event handler 250 replaces the converted value in the user interface 270 with the underlying numerical value.

In even yet further illustration of the operation of the touch event handler 250 and the unit conversion module 300, FIG. 3 is a flow chart illustrating a process for touch toggled unit conversions in a mobile computing device. Beginning in block 310, a query is received in a user interface to an application in the mobile computing device. In block 320 numerical data is received in response to the query and displayed in block 330 in the user interface of the mobile computing device. In block 340 a selection of numerical data is detected in the user interface and in decision block 350, it is determined whether or not a unit conversion is available for the selected numerical data. If not the process ends in block 400. Otherwise, the process continues through decision block 360.

In decision block 360, it is further determined whether or not a sustained or deep enough touching of the user interface proximate to the selected numerical data has commenced. If so, in block 370, unit conversion is performed upon selected numerical data and the converted numerical value replaces the selected numerical data in the user interface for so long as the touching is sustained upon the user interface. In decision block 380, if it is determined that the touching has ended, in block 390 the selected numerical data replaces in the user interface the converted numerical value. Thereafter, the process ends in block 400.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for touch toggled unit conversions in a mobile computing device, the method comprising:
receiving a selection event for numerical data in a user interface displayed on a mobile computing device;
determining in response to the selection event whether or not a unit conversion is available for the numerical data and, if so, displaying a visual indication in the user interface;
detecting a touch event in the user interface in connection with the numerical data, the touch event being sustained in nature or of a threshold force in nature; and,
responding to the touch event by computing a unit conversion of the numerical data from an initial unit of measurement to a different unit of measurement, displaying the numerical data in the different unit of measurement in lieu of the numerical data in the initial unit of measurement, but replacing the numerical data in the different unit of measurement with the numerical data in the initial unit of measurement after the touch event is determined to have ended.

2. The method of claim 1, wherein the unit conversion is a currency conversion.

3. The method of claim 1, wherein the unit conversion is a temperature conversion.

4. The method of claim 1, wherein the unit conversion is a distance conversion.

5. The method of claim 1, wherein the unit conversion is a time zone conversion.

6. The method of claim 1, wherein the unit conversion is a weight conversion.

7. A data processing system configured for touch toggled unit conversions in a mobile computing device, the system comprising:
a mobile computing device comprising memory, a display and at least one processor;
a user interface to an application executing in the memory of the mobile computing device, the application displaying in the user interface numerical data in an initial unit of measurement; and,
a touch toggled unit conversion module coupled to the user interface, the module comprising program code enabled during execution by the processor of the device to receive a selection event for the numerical data, to determine in response to the selection event whether or not a unit conversion is available for the numerical data and, if so, to display a visual indication in the user interface, to detect a touch event in the user interface in connection with the numerical data, the touch event being sustained in nature or of a threshold force in nature, and to respond to the sustained touch event by computing a unit conversion of the numerical data from the initial unit of measurement to a different unit of measurement, by displaying the numerical data in the different unit of measurement in lieu of the numerical data in the initial unit of measurement, and by replacing the numerical data in the different unit of measurement with the numerical data in the initial unit of measurement after the touch event is determined to have ended.

8. The system of claim 7, wherein the unit conversion is a currency conversion.

9. The system of claim 7, wherein the unit conversion is a temperature conversion.

10. The system of claim 7, wherein the unit conversion is a distance conversion.

11. The system of claim 7, wherein the unit conversion is a time zone conversion.

12. The system of claim 7, wherein the unit conversion is a weight conversion.

13. A computer program product for touch toggled unit conversions in a mobile computing device, the computer program product comprising a computer readable storage medium having program instructions embodied therewith, the program instructions executable by a device to cause the device to perform a method comprising:
receiving a selection event for numerical data in a user interface displayed on a mobile computing device;
determining in response to the selection event whether or not a unit conversion is available for the numerical data and, if so, displaying a visual indication in the user interface;
detecting a touch event in the user interface in connection with the numerical data, the touch event being sustained in nature or of a threshold force in nature; and,
responding to the touch event by computing a unit conversion of the numerical data from an initial unit of measurement to a different unit of measurement, displaying the numerical data in the different unit of measurement in lieu of the numerical data in the initial unit of measurement, but replacing the numerical data in the different unit of measurement with the numerical data in the initial unit of measurement after the touch event is determined to have ended.

14. The computer program product of claim 13, wherein the unit conversion is a currency conversion.

15. The computer program product of claim 13, wherein the unit conversion is a temperature conversion.

16. The computer program product of claim 13, wherein the unit conversion is a distance conversion.

17. The computer program product of claim 13, wherein the unit conversion is a time zone conversion.

18. The computer program product of claim 13, wherein the unit conversion is a weight conversion.
